(19) United States
(12) Patent Application Publication
(10) Pub. No.: US 2023/0129227 A1
(43) Pub. Date: Apr. 27, 2023

(54) SYSTEM AND METHOD FOR GENERATING A TABLE-DRIVEN MUTABLE BLOCKCHAIN

(71) Applicant: International Institute of Information Technology, Hyderabab, Hyderabab (IN)

(72) Inventors: Kamalakar Karlapalem, Hyderabab (IN); Suyash Kandele, Hyderabab (IN)

(21) Appl. No.: 17/971,473

(22) Filed: Oct. 21, 2022

(30) Foreign Application Priority Data
Oct. 21, 2021 (IN) 202141048039

(51) Int. Cl. H04L 9/00

(52) U.S. Cl. CPC H04L 9/50

(57) ABSTRACT

A system and method for generating a table-driven mutable blockchain are provided. The system includes one or more users 102A-102N associated with one or more nodes 104A-104N, a distributed file unit 106, a distributed ledger 108. The distributed file unit 106 stores a Lineage Table 200 and a global variable P 112, to keep count on the total number of blockchains in the system. The distributed ledger 108 stores one or more blockchains. The node 104A receives transaction details of transaction provided by user 102A through network 110, and defines transaction. The node 104 initializes linked list structure and creates a transaction of which a plurality of modifications is performed on it. The node 104 creates modified transaction in subsequent blockchains and then links these versions by adding sequence of elements in Linked List. The node 104 authenticates new transactions in main blockchain and the modified transactions in subsequent blockchains.

### CROSS-REFERENCE TO PRIOR-FILED PATENT APPLICATIONS

This application claims priority from the Indian provisional application no. 202041048039 filed on Oct. 21, 2021, which is herein incorporated by reference.

### TECHNICAL FIELD

The embodiments herein generally relate to blockchain technology, and more particularly, to a system and method for generating a table-driven mutable blockchain.

### DESCRIPTION OF THE RELATED ART

In the field of finance, revenue, healthcare industry, law, and computer science a secure public ledger for storing data is a critical responsibility. Using the secure public ledger, users can store their data permanently without any central governing body. That means the secure public ledger provides decentralization, immutability, scalability, limited privacy, and anonymity. Due to the immutability of the secure public ledger, the data is more secure. The secure public ledger is said to be immutable if a record is unaltered and indelible. More succinctly, the data in the secure distributed ledger cannot be altered. Each block of data such as transaction details in revenue proceeds using a cryptographic value.

In some scenarios, transactions need modifications like updating or deleting. For example, smart contracts, a smart contract is an agreement among two or more parties or people in the form of a computer code. The smart contracts run on the secured distributed ledger. They are processed by the secured distributed ledger. The smart contracts need to be updated if any changes are required. But smart contracts on the secured distributed ledger may not be updated as the data on the secured distributed ledger is immutable.

The existing techniques to design mutable blockchains include off-chaining, redactable blockchains, consensus layer on the blockchain, and memory flexible blockchain. The off-chaining requires a mechanism to bypass a blockchain's immutability. In this technique, only the transaction identifier (i.e. the unique identity number of each transaction) is stored in the block (or blockchain), and the transaction itself is stored separately in a mutable (encrypted) hash file. The security of a transaction is dependent on the safety and management of the key. In the existing techniques, one of the methods to remove or edit the contents of a transaction is to make the data available as usual on the Web, with transactions in the blockchain containing simply a pointer to the content and its hash. One of the existing techniques has proposed a Memory Optimized and Flexible Blockchain (MOF-BC) in which the transaction contents are separated from the Merkle root of the blockchain, and stored in separate encrypted files. It offers greater flexibility in the storage of transactions and data of IoT devices. Another existing technique has proposed a solution that supports the General Data Protection Regulation (GDPR) by giving complete control of the data to its owner and has discussed various advantages and disadvantages of this mechanism. The personal data is being stored off-chain. The reference to this data, along with the hash and other metadata is stored in the blockchain. The technique supersedes the fundamental property of immutability of the blockchain in a way that the data can be modified as and when required without any record of the successive versions.

The method of redactable blockchains suggests the use of various cryptographic primitives with backdoors or trapdoors, for storing the transaction content, and editing or removing the contents with the help of the backdoor or trapdoor. One of the existing techniques has suggested the careful use of encryption schemes to impart privacy to the transaction contents. It has an associated overhead of secure key storage and efficient key management. Another existing technique has proposed the use of chameleon hash, which contains a trapdoor, to change the content without changing the hash. This technique introduces vulnerabilities in the blockchain due to attacks on the weak underlying cryptographic tool and is susceptible to the discovery of loopholes or the advent of new cryptanalytic techniques such as quantum computing.

Adding a consensus layer on blockchain was proposed by another existing technique. The solution allows alternate histories of a blockchain and uses consensus to decide on the final changed block. This introduces the vulnerability in the blockchain, where a group of nodes can influence the agreement on the final block.

In Memory flexible blockchain, the hash of the block is computed on hashes of the transactions, and not transaction contents. Thus, changing the content does not change the block hash. It requires the knowledge of transaction identifiers in advance and central management of ensuring the safety of transaction identifiers and their corresponding key management. Moreover, this technique revokes the immutability property of the blockchain.

In all the above solutions, the person who decides that an error had occurred while creating the transaction and the one who initiates the update(s) is the creator of the original transaction itself.

The above existing solutions for mutable blockchain either demand a fundamental change in the properties and structure of blockchain or introduces a cryptographic weakness.

Therefore, there arises a need to address the aforementioned technical drawbacks in existing technologies to design a mutable distributed ledger without changing the fundamental properties of blockchain and without introducing weaknesses.

### SUMMARY

In one aspect, there is provided a table-driven mutable blockchain system for enabling to modify at least one transaction in at least one block of at least one first blockchain and generating at least one second blockchain with modified transaction. The blockchain system includes a distributed file unit that is configured to store a lineage table (LT), and a global variable. The LT stores a version history of at least one transaction and the global variable comprises a count on a number of blockchains in the table-driven mutable blockchain. The blockchain system includes a distributed ledger. The distributed ledger includes one or more blockchains. The one or more blockchains store data indicating the at least one transaction associated with each user. The one or more nodes are associated with one or more users. The one or more nodes includes at least one hybrid node. The at least one hybrid node includes a device processor and a non-transitory computer-readable storage medium storing one or more sequences of instructions, which when executed by the device processor, causes: (i) generating a first transaction by defining at least one input transaction, at least one output transaction or at least one data element; (ii) broadcasting the first transaction in the at least one first blockchain; (iii) creating a first entry, in the LT, for the first transaction; (iv) generating a second transaction by modifying the first transaction after ensuring that none of the output transactions in the first transaction have been spent by at least one beneficiary; (v) broadcasting the second transaction in at least one second blockchain, the at least one second blockchain is generated based on a first transaction identifier in the at least one first blockchain and the first entry in the LT for the first transaction; and (v) updating the LT with a second entry for the second transaction to create the version history of the at least one transaction in the LT.

In some embodiments, the processor is configured to generate the first transaction by, (i) collecting transaction details to prepare details of the at least one input transaction, and the at least one output transaction, (ii) determining details of the at least one input transaction by computing a transaction identifier a first index for the at least one input transaction and revealing an unlocking condition of the at least one input transaction, the unlocking condition is usually a cryptographic signature, (iii) determining details of the at least one output transaction by computing a second index for the at least one output transaction and defining an unlocking condition of the first transaction and a size of the unlocking condition, (iv) generating the first transaction using details of the at least one data element by (a) defining a public key and a size of the public key, (b) defining and writing data into data value field of the first transaction and a size of the data into size value field of the first transaction, and (c) computing a signature and a size of the signature on the data value field of the first transaction, (v) computing a number of input transactions and a number of output transactions to corresponding an input count field and an output count field, (vi) inserting a creation time stamp of the first transaction to a timestamp field and blockchain software version information in a version field, (vii) storing a hash of the at least one input transaction, the at least one output transaction, and the at least one data element as the transaction identifier, (viii) updating the LT table by creating the first entry by initializing the transaction identifier and computing the signature, and (ix) identifying a row corresponding to the transaction identifier in the LT table to store the first entry.

In some embodiments, the processor is configured to generate the second transaction by modifying the first transaction by, (i) updating the first transaction based on the transaction details, (ii) adding the second entry in the LT table, (iii) determining the index of the blockchain that comprises a latest version of the second transaction, (iv) checking if the index is equal to the global variable, (v) updating the global variable by adding one if the index is equal to the global variable, (vi) creating the at least one second blockchain, (vii) preparing details of the at least one output transaction, (viii) preparing details of the at least one data element to write the data into a field of data value and a size of the data into a field of data size, a public key and a size of the public key are defined to the at least one data element, (ix) assigning a value to the transaction identifier of the second transaction to compute a number of output transactions, (x) initializing a number to a field of number of the blockchain, (xi) inserting a creation time stamp of the second transaction to the timestamp field and blockchain software version information in the version field, (xii) computing and storing the hash of the at least one input transaction and the at least one output transaction, as the transaction identifier, (xiii) computing and storing the signature of the at least one input transaction and the at least one output transaction, in a field of transaction signature, (xiv) broadcasting the second transaction that is created newly, (xv) updating the LT table by initializing the transaction identifier of the second transaction and a pointer and computing the signature, (xvi) identifying a row corresponding to the transaction identifier of the second transaction in the LT table to extract the linked list, (xvi) updating the pointer of last element of the linked list to the element of the first transaction, and (xvii) appending the first transaction as the last element in the linked list and updating the LT table.

In some embodiments, the processor is configured to verify the first transaction and the second transaction that is modified of the table-driven mutable blockchain by, (i) collecting the transaction details of transaction and aborts verification process if the transaction details are not found, (ii) checking if any of the at least one input transaction for the verification if a value of block chain number field is one and checking if the script signature is present for all the input transactions, (iii) checking if any of the at least one output transaction is executed by the user when the hash of the first transaction is matched with the transaction identifier, (iv) checking if the signature on transaction content matches with a value of transaction content signature field, (v) checking if the hash of the first transaction content matches with the transaction identifier, (vi) checks if sum of all the amounts in the at least one output transaction is less than or equal to that in the amounts in the at least one input transaction, and (vii) verifying the signature on data value and values in other fields for correctness, thereby accepting the transaction.

In some embodiments, the processor is configured to create the at least one second block for the at least one second blockchain of the table-driven mutable blockchain by, (i) collecting the transaction details and preparing a list of transactions, (ii) checking if each transaction in the list of transactions matches with same value for the value of blockchain number field, (iii) checking correctness of each transaction in the list of transactions, (iv) computing the number of transactions in the list of transactions if the correctness and the matching in previous steps are successful and inserting the blockchain software version information in a field of software version and assigning the value of hash of the latest block in existing blockchain, (v) computing a merkle root of the transactions and a puzzle, and (vi) preparing a header of the block in a format, and the block in the format.

In some embodiments, the processor is configured to mine the first block of the table-driven mutable blockchain by, (i) collecting all new transactions and preparing a list of all new transactions that are valid in one blockchain, (ii) computing a candidate block that comprises the list of transactions with the list of all new transactions that are valid, (iii) computing a solution of the puzzle as nonce field, and (iv) computing and storing the hash of the header of the block and the size of the block.

In some embodiments, the processor is configured to retrieve a latest version of the transaction of the table-driven mutable blockchain by, (i) collecting transaction details of the transaction, (ii) extracting a linked list for the transaction identifier in the LT, and verifying the signature stored in each element of the linked list, (iii) extracting a first element for the transaction and a last element of the transaction, (iv) extracting and verifying the transaction from the first blockchain, and the transaction from the i^{th} blockchain, and (v) extracting and returning the input transactions, the output transactions, and data elements from the input transactions, the output transactions, and the data elements.

In some embodiments, the processor is configured to retrieve all versions of the at least one transaction of the table-driven mutable blockchain by, (i) extracting the linked list for the transaction identifier in the LT, and verifying the signature stored in each element of the linked list, (ii) extracting and verifying elements for the transactions for blockchains in the linked list, (iii) extracting and verifying all the transactions from the blockchains in the linked list, and (iv) extracting and returning the input transactions, the output transactions, the data elements, from the transactions.

In another aspect, there is provided a processor-implemented method for enabling to modify at least one transaction in at least one block of at least one first blockchain and generating at least one second blockchain with modified transaction. The processor-implemented method includes (i) configuring, by a distributed file unit, to store a lineage table (LT), and a global variable, the LT stores a version history of at least one transaction and the global variable comprises a count on a number of blockchains in the table-driven mutable blockchain, (ii) configuring, by a distributed ledger, to comprise a plurality of blockchains, the plurality of blockchains store data indicating the at least one transaction associated with each user, (iii) generating a first transaction, using a plurality of nodes associated with a plurality of users, by defining at least one input transaction, at least one output transaction or at least one data element, the plurality of nodes comprise at least one hybrid node, (iv) broadcasting the first transaction in the at least one first blockchain; (v) creating a first entry, in the LT, for the first transaction; (vi) generating a second transaction by modifying the first transaction after ensuring that none of the output transactions in the first transaction have been spent by at least one beneficiary; (vii) broadcasting the second transaction in at least one second blockchain, the at least one second blockchain is generated based on a first transaction identifier in the at least one first blockchain and the first entry in the LT for the first transaction; and (viii) updating the LT with a second entry for the second transaction to create the version history of the at least one transaction in the LT.

In some embodiments, the method further includes generating the first transaction by, (i) collecting transaction details to prepare details of the at least one input transaction, and the at least one output transaction, (ii) determining details of the at least one input transaction by computing a transaction identifier a first index for the at least one input transaction and revealing an unlocking condition of the at least one input transaction, the unlocking condition is usually a cryptographic signature, (iii) determining details of the at least one output transaction by computing a second index for the at least one output transaction and defining an unlocking condition of the first transaction and a size of the unlocking condition, (iv) generating the first transaction using details of the at least one data element by (a) defining a public key and a size of the public key, (b) defining and writing data into data value field of the first transaction and a size of the data into size value field of the first transaction, and (c) computing a signature and a size of the signature on the data value field of the first transaction, (v) computing a number of input transactions and a number of output transactions to corresponding an input count field and an output count field, (vi) inserting a creation time stamp of the first transaction to a timestamp field and blockchain software version information in a version field, (vii) storing a hash of the at least one input transaction, the at least one output transaction, and the at least one data element as the transaction identifier, (viii) updating the LT table by creating the first entry by initializing the transaction identifier and computing the signature, and (ix) identifying a row corresponding to the transaction identifier in the LT table to store the first entry.

In some embodiments, the method further includes generating the second transaction by modifying the first transaction by, (i) updating the first transaction based on the transaction details, (ii) adding the second entry in the LT table, (iii) determining the index of the blockchain that comprises a latest version of the second transaction, (iv) checking if the index is equal to the global variable, (v) updating the global variable by adding one if the index is equal to the global variable, (vi) creating the at least one second blockchain, (vii) preparing details of the at least one output transaction, (viii) preparing details of the at least one data element to write the data into a field of data value and a size of the data into a field of data size, a public key and a size of the public key are defined to the at least one data element, (ix) assigning a value to the transaction identifier of the second transaction to compute a number of output transactions, (x) initializing a number to a field of number of the blockchain, (xi) inserting a creation time stamp of the second transaction to the timestamp field and blockchain software version information in the version field, (xii) computing and storing the hash of the at least one input transaction and the at least one output transaction, as the transaction identifier, (xiii) computing and storing the signature of the at least one input transaction and the at least one output transaction, in a field of transaction signature, (xiv) broadcasting the second transaction that is created newly, (xv) updating the LT table by initializing the transaction identifier of the second transaction and a pointer and computing the signature, (xvi) identifying a row corresponding to the transaction identifier of the second transaction in the LT table to extract the linked list, (xvi) updating the pointer of last element of the linked list to the element of the first transaction, and (xvii) appending the first transaction as the last element in the linked list and updating the LT table.

In some embodiments, the method further includes verifying the first transaction and the second transaction that is modified of the table-driven mutable blockchain by, (i) collecting the transaction details of transaction and aborts verification process if the transaction details are not found, (ii) checking if any of the at least one input transaction for the verification if a value of block chain number field is one and checking if the script signature is present for all the input transactions, (iii) checking if any of the at least one output transaction is executed by the user when the hash of the first transaction is matched with the transaction identifier, (iv) checking if the signature on transaction content matches with a value of transaction content signature field, (v) checking if the hash of the first transaction content matches with the transaction identifier, (vi) checks if sum of all the amounts in the at least one output transaction is less than or equal to that in the amounts in the at least one input transaction, and (vii) verifying the signature on data value and values in other fields for correctness, thereby accepting the transaction.

In some embodiments, the method further includes creating the at least one second block for the at least one second blockchain of the table-driven mutable blockchain by, (i) collecting the transaction details and preparing a list of transactions, (ii) checking if each transaction in the list of transactions matches with same value for the value of blockchain number field, (iii) checking correctness of each transaction in the list of transactions, (iv) computing the number of transactions in the list of transactions if the correctness and the matching in previous steps are successful and inserting the blockchain software version information in a field of software version and assigning the value of hash of the latest block in existing blockchain, (v) computing a merkle root of the transactions and a puzzle, and (vi) preparing a header of the block in a format, and the block in the format.

In some embodiments, the method further includes mining the first block of the table-driven mutable blockchain by, (i) collecting all new transactions and preparing a list of all new transactions that are valid in one blockchain, (ii) computing a candidate block that comprises the list of transactions with the list of all new transactions that are valid, (iii) computing a solution of the puzzle as nonce field, and (iv) computing and storing the hash of the header of the block and the size of the block.

In some embodiments, the method further includes retrieving a latest version of the transaction of the table-driven mutable blockchain by, (i) collecting transaction details of the transaction, (ii) extracting a linked list for the transaction identifier in the LT, and verifying the signature stored in each element of the linked list, (iii) extracting a first element for the transaction and a last element of the transaction, (iv) extracting and verifying the transaction from the first blockchain, and the transaction from the i^{th} blockchain, and (v) extracting and returning the input transactions, the output transactions, and data elements from the input transactions, the output transactions, and the data elements.

In some embodiments, the method further includes retrieving all versions of the at least one transaction of the table-driven mutable blockchain by, (i) extracting the linked list for the transaction identifier in the LT, and verifying the signature stored in each element of the linked list, (ii) extracting and verifying elements for the transactions for blockchains in the linked list, (iii) extracting and verifying all the transactions from the blockchains in the linked list, and (iv) extracting and returning the input transactions, the output transactions, the data elements, from the transactions.

In another aspect, there is provided one or more non-transitory computer-readable storage mediums storing one or more sequences of instructions, which when executed by one or more processors, causes a method for enabling to modify at least one transaction in at least one block of at least one first blockchain and generating at least one second blockchain with modified transaction. The method includes (i) configuring, by a distributed file unit, to store a lineage table (LT), and a global variable, the LT stores a version history of at least one transaction and the global variable comprises a count on a number of blockchains in the table-driven mutable blockchain, (ii) configuring, by a distributed ledger, to comprise a plurality of blockchains, the plurality of blockchains store data indicating the at least one transaction associated with each user, (iii) generating a first transaction, using a plurality of nodes associated with a plurality of users, by defining at least one input transaction, at least one output transaction or at least one data element, the plurality of nodes comprise at least one hybrid node, (iv) broadcasting the first transaction in the at least one first blockchain; (v) creating a first entry, in the LT, for the first transaction; (vi) generating a second transaction by modifying the first transaction after ensuring that none of the output transactions in the first transaction have been spent by at least one beneficiary; (vii) broadcasting the second transaction in at least one second blockchain, the at least one second blockchain is generated based on a first transaction identifier in the at least one first blockchain and the first entry in the LT for the first transaction; and (viii) updating the LT with a second entry for the second transaction to create the version history of the at least one transaction in the LT.

The table-driven mutable blockchain system provides modifying or deleting the existing transactions in a blockchain. For example, smart contracts need to be updated if any changes are required. But smart contracts on the secured distributed ledger may be updated using the table-driven mutable blockchain system. The table-driven mutable blockchain system provides retrieval of the latest version and all versions of the transaction. The system does not disrupt the core structure and properties of the blockchain.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a table-driven mutable blockchain system for enabling to modify a transaction in a block of first blockchain and generating a second blockchain with modified transaction, according to some embodiments herein;

FIG. 2 illustrates an exemplary representation of a Lineage Table (LT) in a table-driven mutable blockchain system, according to some embodiments herein;

FIG. 3 illustrates an exemplary representation of a block of the blockchain in a table-driven mutable blockchain system, according to some embodiments herein;

FIGS. 4A and 4B illustrate an exemplary representation of a first transaction in a first blockchain, and a second transaction in a second blockchain in a table-driven mutable blockchain system, according to some embodiments herein;

FIG. 5 is a block diagram of a hybrid node of the table-driven mutable blockchain system, according to some embodiments herein;

FIG. 6 is a flow diagram that illustrates a method of creating a first transaction in the first blockchain, of the table-driven mutable blockchain system, according to some embodiments herein;

FIG. 7 is a flow diagram that illustrates a method of creating a second transaction in the second blockchain, of the table-driven mutable blockchain system, according to some embodiments herein;

FIG. 8 is a flow diagram that illustrates a method of verifying existing first and second transactions of the table-driven mutable blockchain system, according to some embodiments herein;

FIG. 9 is a flow diagram that illustrates a method of verifying existing first and second blocks, of the table-driven mutable blockchain system, according to some embodiments herein;

FIG. 10 is a flow diagram that illustrates a method of verifying new first and second transactions of the table-driven mutable blockchain system, according to some embodiments herein;

FIG. 11 is a flow diagram that illustrates a method of creating first and second blocks, of the table-driven mutable blockchain system, according to some embodiments herein;

FIG. 12 is a flow diagram that illustrates a method of mining first and second blocks, of the table-driven mutable blockchain, according to some embodiments herein;

FIG. 13 is a flow diagram that illustrates a method of retrieving the latest version of a transaction, of the table-driven mutable blockchain system, according to some embodiments herein;

FIG. 14 is a flow diagram that illustrates a method of retrieving all the versions of a transaction, of the table-driven mutable blockchain system, according to some embodiments herein;

FIG. 15 is a flow diagram that illustrates a method of retrieving the list of all transactions corresponding to a user, of the table-driven mutable blockchain system, according to some embodiments herein;

FIG. 16 is a flow diagram that illustrates a method of retrieving the current balance of a user, of the table-driven mutable blockchain system, according to some embodiments herein;

FIGS. 17A and 17B are flow diagrams that illustrate a method for enabling to modify a transaction in a block of first blockchain and generating a second blockchain with modified transaction, of the table-driven mutable blockchain system, according to some embodiments herein; and

FIG. 18 is a schematic diagram of a computer architecture in accordance with the embodiments herein.

### DETAILED DESCRIPTION OF THE DRAWINGS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

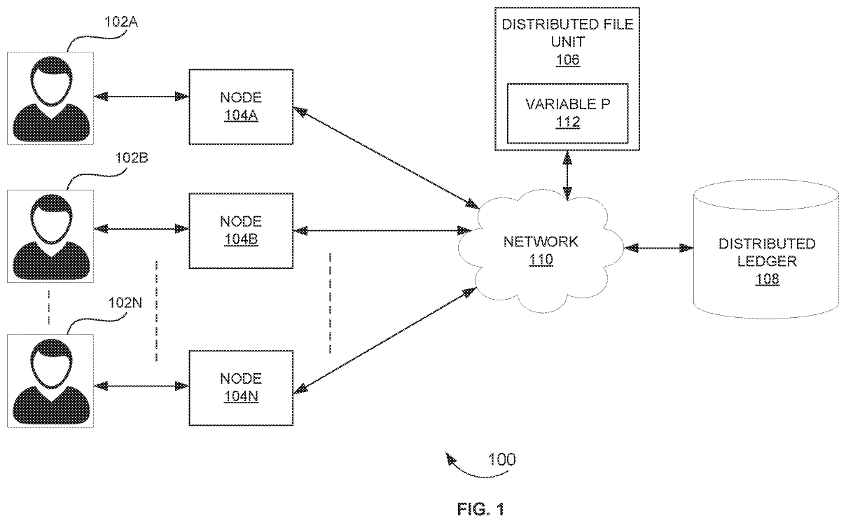

As mentioned, there is a need for a system and method for generating a table-driven mutable blockchain. Referring now to the drawings, and more particularly to FIG. 1 through FIG. 18, where similar reference characters denote corresponding features consistently throughout the figures, preferred embodiments are shown.

FIG. 1 illustrates a table-driven mutable blockchain system 100 for enabling to modify a transaction in a block of first blockchain and generating a second blockchain with modified transaction, according to some embodiments herein. The table-driven mutable blockchain system 100 includes one or more users 102A-102N, associated with one or more nodes 104A-104N, a distributed file unit 106 containing a global variable P 112, a distributed ledger 108, and a network 110. The distributed file unit 106 stores a Lineage Table (LT), to store the version history of a transaction and a global variable P 112, that keeps a count on the number of blockchains (or the maximum number of updates on any transaction) in the table-driven mutable blockchain system 100. The distributed file unit 106, may be an IPFS (Inter-Planetary File System). The nodes 104A-104N, the distributed file unit 106, and the distributed ledger 108 are connected to each other through a network 110. In some embodiments, the one or more nodes 104A-104N maybe, but not be limited to a tablet, a personal computer, a laptop, a smartphone, or any hardware device related to blockchain systems. In some embodiments, the network 110 may be a peer-to-peer network. In some embodiments, the network 110 is a wireless network. In some embodiments, the network 110 is a combination of the wired network and the wireless network. In some embodiments, the network 110 is the Internet.

The distributed ledger 108 may be a blockchain infrastructure that stores all the blockchains in the table-driven mutable blockchain system 100. Further, the distributed ledger 108 stores data indicating a transaction associated with each of the user 102A-102N. In some embodiments, the transaction associated with each of the user 102A-102N in each block maybe, but not limited to, transferring money, writing a smart contract, or committing to data. The one or more users 102A-102N define input and output transactions in the event of monetary transactions or contracts. The one or more users 102A-102N provide transaction details of the transaction through a user interface of the one or more nodes 104A-104N. The transaction details may include one or more attributes of the transaction like a set of data for each input transaction, a set of data for each output transaction, a set of values for data to commit to. In some embodiments, the transaction details related to maybe, but not limited to, transferring money, writing a contract, or committing to data, for monetary transactions or contracts.

The one or more nodes 104A-N includes at least one hybrid node. The at least one hybrid node includes a device processor and a non-transitory computer-readable storage medium storing one or more sequences of instructions, which when executed by the device processor, causes: (i) generating a first transaction by defining at least one input transaction, at least one output transaction or at least one data element; (ii) broadcasting the first transaction in the at least one first blockchain; (iii) creating a first entry, in the LT, for the first transaction; (iv) generating a second transaction by modifying the first transaction after ensuring that none of the output transactions in the first transaction have been spent by at least one beneficiary; (v) broadcasting the second transaction in at least one second blockchain, the at least one second blockchain is generated based on a first transaction identifier in the at least one first blockchain and the first entry in the LT for the first transaction; and (v) updating the LT with a second entry for the second transaction to create the version history of the at least one transaction in the LT.

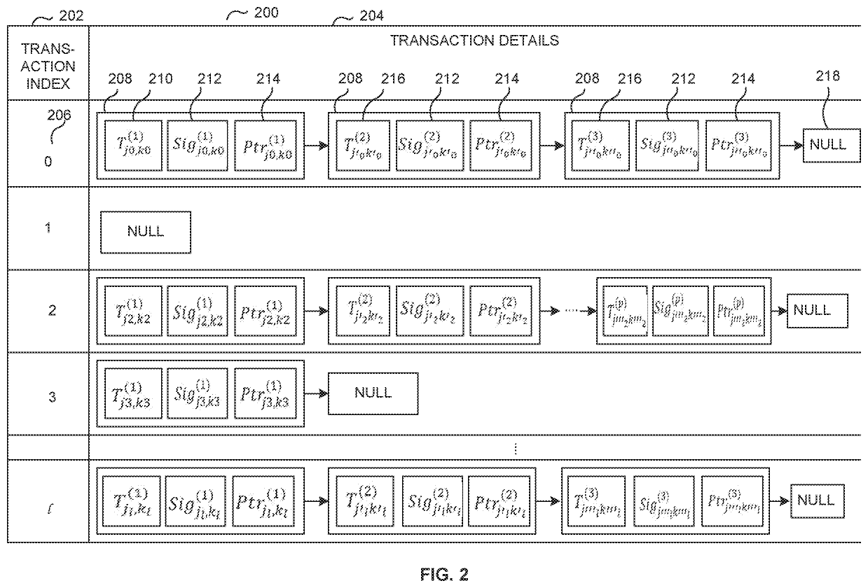

FIG. 2 illustrates an exemplary representation of the Lineage Table (LT) 200 in a table-driven mutable blockchain system 100, according to some embodiments herein. The exemplary representation of a Lineage Table 200 includes two columns. The first column 202 of the Lineage Table 200 stores an index 206, a value that depends on a hash function to generate a transaction identifier for the transactions of the main blockchain, for example, 0, 1, and so on. The second column 204 of the Lineage Table 200 stores an entry for the transaction in the main blockchain, whose transaction identifier matches with the index 206. The Lineage Table 200 is stored in the distributed file unit 106. The entry of the transaction is a linked list structure. The element 208 of the linked list may include the transaction identifier 210 or 216, a signature on the transaction identifier 212, and a pointer 214 to next element 208. The transaction identifier for the first element of the linked list is 210, and the value of 210 is equal to the value of the index 206. For all other elements, the transaction identifier is 216. The pointer 214 of the last element 208 of each linked list structure may be assigned a special value NULL 218.

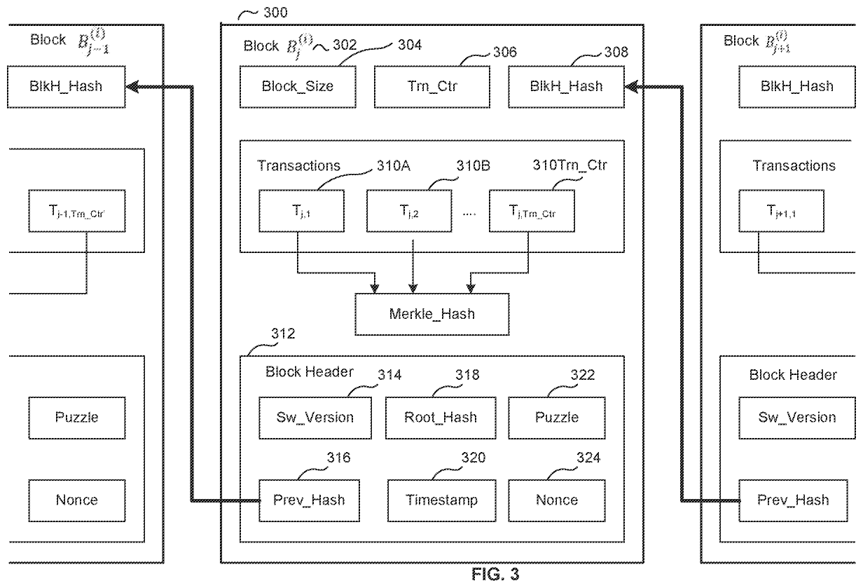

FIG. 3 illustrates an exemplary representation of a block of the blockchain in a table-driven mutable blockchain system 100, according to some embodiments herein. The block 300 includes size of block Block_Size 304, a transaction counter Trn_Ctr 306, one or more mined transactions 310A-310Trn_Ctr, a block header 312 including the software version of the blockchain infrastructure as Sw_Version 314, a pointer to the previous block in the blockchain as Prev_Hash 316, the hash of the root of the Merkle-tree formed by the transactions 310A-310Trn_Ctr, stored as Root_Hash 318, the creation time of the block is retained as Timestamp 320, the difficulty level of proof-of-work in the mining algorithm Puzzle 322, and the solution of the Puzzle 322 is preserved as Nonce 324. The transaction counter Trn_Ctr 306 marks the number of transactions that have been successfully mined. The exemplary representation of a block 300 in the blockchain B⁽ⁱ⁾ in a table-driven mutable blockchain system. A block 300 in the blockchain infrastructure includes one or more transactions associated with one or more user nodes that are authenticated. Each block Bⱼ⁽ⁱ⁾ 302 may be identified using its height j in Blockchain B⁽ⁱ⁾. The block 300 also includes an another unique identifier BlkH_Hash 308 such that no two blocks in a blockchain B⁽ⁱ⁾ may have the same identifier. Each block 300 includes one or more attributes.

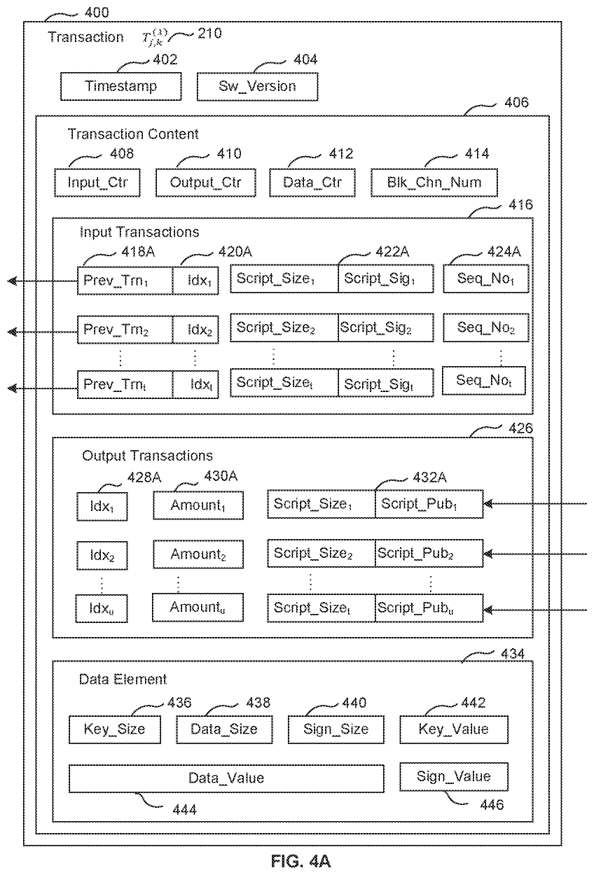

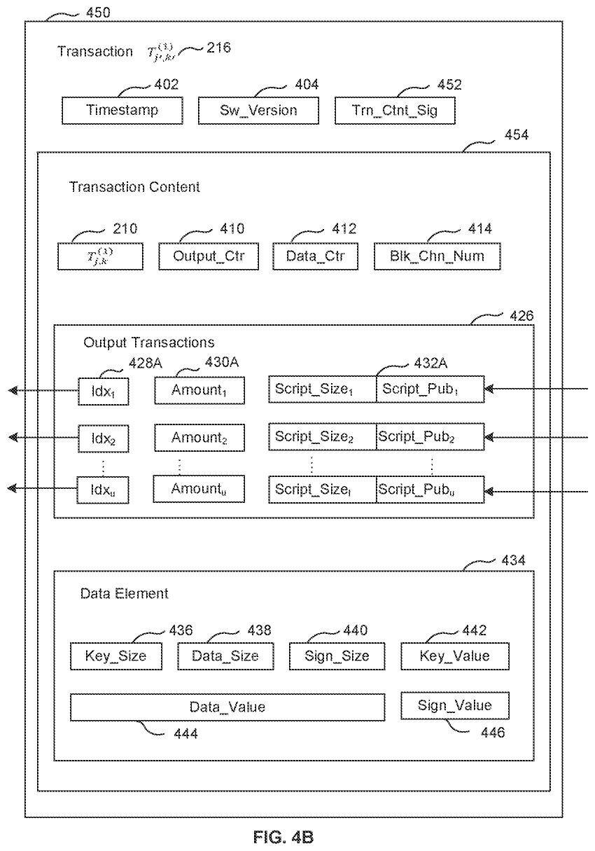

FIGS. 4A and 4B illustrate an exemplary representation of a first transaction in a first blockchain, and a second transaction in a second blockchain in a table-driven mutable blockchain system 100, according to some embodiments herein. The exemplary representation 400 includes the transaction 400 in the first blockchain B⁽¹⁾ and a second transaction 450 in the second blockchain B⁽ⁱ⁾ (for 0<i<=p) in a table-driven mutable blockchain system. The first transaction 400 in the first blockchain B⁽¹⁾ has a unique identifier T_{j,k}⁽¹⁾ 210 (as shown in FIG. 2) computed as the hash of the transaction content 406 T_{j,k}⁽¹⁾ can also be uniquely identified as the k-th transaction that has been mined (or verified) in the j-th block Bⱼ⁽¹⁾ of the first blockchain B⁽¹⁾. The exemplary representation of the first transaction 400 includes, a Timestamp 402, a Sw_Version 404 and a transaction content 406. The Timestamp 402 stores the time at which the transaction is created. The Sw_Version 404 stores the software version of the blockchain infrastructure. The transaction content section 406 includes, an Input_Ctr 408, an Output_Ctr 410, a Data_Ctr 412, a Bik_Chn_Num 414, input transactions 416, output transactions 426 and a data element 434 where the transaction details provided by the user 102A-102N are classified and stored respectively. The Input_Ctr 408 stores the number of unspent transactions that the user 102A-102N wishes to spend. For example, consider the table-driven mutable blockchain model is used on a banks transaction and the transaction involves receiving money from other user, then the Input_Ctr 408 stores the number of transactions which is not yet used or is unspent by the user. The Output_Ctr 410 stores the number of unspent transactions that the user 102A-102N wants to spend for another user 102A-102N. For example, the Output_Ctr 410 stores the transaction information of the money that the user wants to send to another person/account. The Data_Ctr 412 stores the total size of the Data element 434. The Blk_Chn_Num 414 is the index of blockchain where this transaction must be added. The input transactions 416 include Prev_Trn₁-Prev_Trnₜ 418A-418T, Idxₗ-Idxₜ 420A-420T, Script_Size₁-Script_Sizeₜ and Script_Sig₁-Script_Sigₜ 422A-422T and Seq_No₁-Seq_Noₜ 424A-424T. The Prev_Trn₁-Prev_Trnₜ 418A-418T and the Idx₁-Idxₜ 420A-420T collectively forms a unique identifier of a transaction, where the Prev_Trn₁-Prev_Trnₜ 418A-418T refers to the transaction identifier 210 of the transaction in the first blockchain B⁽¹⁾ that are unspent and the Idx₁-Idxₜ 420A-420T sets the range of the index/position of the output transaction 426 in a latest version of the transaction with same value of the Prev_Trn₁-Prev_Trnₜ 418A-418T. In some embodiments, the Script_Size₁-Script_Sizeₜ and the Script_Sig₁-Script_Sigₜ fields 422A-422T may have an unlocking condition which needs to be fulfilled to allow entry of the amount for the transaction. In some embodiments, the table-driven mutable blockchain model may reveal the unlocking condition of the Script_Size₁-Script_Sizeₜ and the Script_Sig₁-Script_Sigₜ fields 422A-422T after computing the Prev_Tm₁-Prev_Tmₜ 418A-418T and the Idx₁-Idxₜ 420A-420T. The Script_Sig₁-Script_Sigₜ 422A-422T stores the signature given by the user 102A-102N which needs to satisfy the unlocking condition. The Script_Size₁-Script_Sizeₜ stores the size of the Script_Sig₁-Script_Sigₜ. The Seq_No₁-Seq_Noₜ 424A-424T helps in enabling or disabling an advanced function which is a lock time of the transaction. The output transactions 426 include, Idx₁-Idxᵤ 428A-428U, Amount₁-Amountᵤ 430A-430U, and Script_Size₁-Script_Sizeᵤ and Script_Pub₁-Sscript_Pubᵤ 432A-432U. The Idx₁-Idxᵤ 428A-428U sets the range of the index/position of the output transactions 426. The Amount₁-Amountᵤ 430A-430U stores the amount of money that is being transferred through the transaction. The Script_Pub₁-Script_Pubᵤ 432A-432U of the output transactions 426 stores a key which matches to the Script_Sig₁-Script_Sigₜ 422A-422T from the input transactions 416 given by the user 102A-102N. In some embodiments, the Script_Pub₁-Script_Pubᵤ 432A-432U defines an unlocking condition, that is the public key, and allows the user 102A-102N spend or use the amount of money in Amount₁-Amountᵤ 430A-430U only when it satisfies the unlocking condition. The Script_Size₁-Script_Sizeᵤ stores the size of the Script_Pub₁-Script_Pubᵤ. The data element 434 includes a Key_Size, a Data_Size, a Sign_Size, a Data_Value, a Key_Value and a Sign_Value. The Key_Size 436 stores the size of Key_value 442. The Key_Value 442 stores a public key for the verification of the signature on Data_value 444. The Data_Size 438 stores the size of the Data_Value 444. The Data_Value 444 stores the data to which the user 102A-102N wants to commit to. For example, the Data_Value 444 can store a contract details making it a smart contract with the features of the table-driven mutable blockchain module. The Sign_Size 440 stores the size of the Sign_Value 446. The Sign Value 446 stores the signature given by the user 102A-102N on the Data_Value 444 which can be verified with the Key_Value 442.

The second transaction 450 is a new transaction which is created when a transaction is modified or updated. The second transaction 450 in the second blockchain B⁽ⁱ⁾ has a unique identifier T_{j′,k′(i)} 216 (as shown in FIG. 2) computed as the hash of the transaction content 454. T_{j′,k′(i)} can also be uniquely identified as the k′-th transaction that has been mined (or verified) in the j′-th block B_{j′}⁽ⁱ⁾ of the main blockchain B⁽ⁱ⁾. The second transaction 450 includes the Timestamp 402, the Sw_Version 404, an additional field, Trn_Ctnt_Sig 452 and a modified transaction content 454. The Timestamp 402 stores the time at which the transaction is created. The Sw_Version 404 stores the software version of the blockchain infrastructure. The Trn_Ctnt_Sig stores the signature on the modified transaction content 454. The transaction content section 454 includes, a T_{j,k}⁽¹⁾ 210, an Output_Ctr 410, a Data_Ctr 412, a Blk_Chn_Num 414, output transactions 426 and a data element 434. The transaction details provided by the user 102A-102N are classified and stored respectively. The T_{j,k}⁽¹⁾ 210 stores the identifier of the original transaction in the first blockchain B⁽¹⁾. The Output_Ctr 410 stores the number of unspent transactions that the user 102A-102N modifies and wants to spend for another user 102A-102N. For example, the Output_Ctr 410 stores the updated transaction information of the money that the user wants to send to another person/account. The Data_Ctr 412 stores the total size of the Data element 434 that is modified. The Blk_Chn_Num 414 is the index of blockchain where this transaction must be added. The output transactions 426 include, Idx₁-Idxᵤ 428A-428U, Amount₁-Amountᵤ 430A-430U, and Script_Size₁-Script_Sizeᵤ and Script_Pub₁-Sscript_Pubᵤ 432A-432U. The Idx₁-Idxᵤ 428A-428U sets the range of the index/position of the output transactions 426. The Amount₁-Amountᵤ 430A-430U stores the amount of money that is being transferred through the transaction. The Script_Pub₁-Script_Pubᵤ 432A-432U of the output transactions 426 stores a key which matches to the Script_Sig₁-Script_Sigᵤ 422A-422T from the input transactions 416 given by the user 102A-102N. In some embodiments, the Script_Pub₁-Script_Pubᵤ 432A-432U defines an unlocking condition, that is the public key, and allows the user 102A-102N spend or use the amount of money in Amount₁-Amountᵤ 430A-430U only when it satisfies the unlocking condition. The Script_Size₁-Script_Sizeᵤ stores the size of the Script_Pub₁-Script_Pubᵤ. In some embodiments, one or more above mentioned components of the output transaction 426 can be modified. The data element 434 includes a Key_Size, a Data_Size, a Sign_Size, a Data_Value, a Key_Value and a Sign_Value. The Key_Size 436 stores the size of Key_value 442. The Key_Value 442 stores a public key for the verification of the signature on Data_value 444. The Data_Size 438 stores the size of the Data_Value 444. The Data_Value 444 stores the data to which the user 102A-102N wants to commit to. For example, the Data_Value 444 can store a contract details making it a smart contract with the features of the table-driven mutable blockchain module. The Sign_Size 440 stores the size of the Sign_Value 446. The Sign_Value 446 stores the signature given by the user 102A-102N on the Data_Value 444 which can be verified with the Key_Value 442. In some embodiments, one or more above mentioned components of data element 434 can be modified.

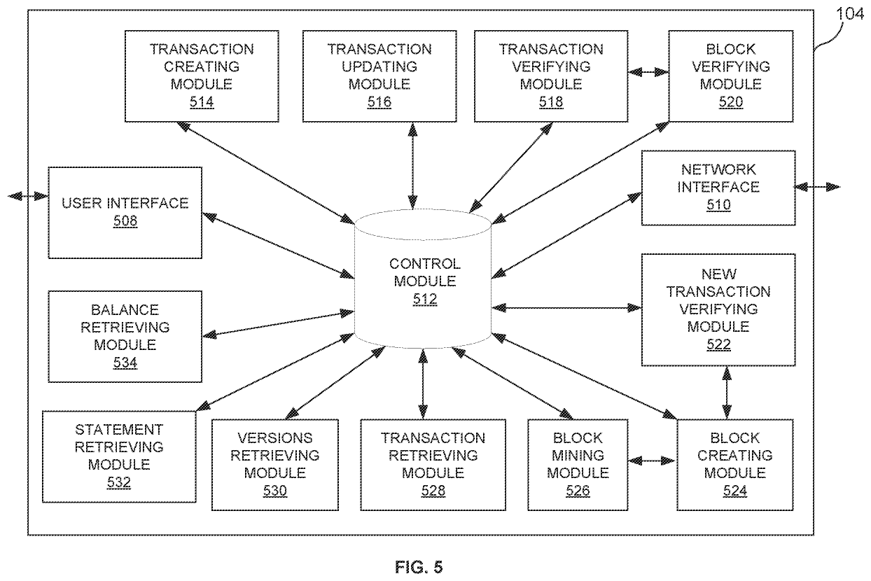

FIG. 5 is a block diagram of a hybrid node, respectively, of the table-driven mutable blockchain system 100, according to some embodiments herein. There are three kinds of nodes 104 in a table-driven mutable blockchain system 100—a simple node, a miner node and a hybrid node. In some embodiments, the simple node includes the basic functionalities of the table-driven mutable blockchain for the user 102 to create a new transaction, update the transactions, verify the transactions and blocks of the existing blockchain, and provides access to the retrieval functions. In some embodiments, the miner node includes the functionalities required for mining new blocks (i.e. verifying and approving new transactions by grouping them in blocks and then approving the blocks), and to verify the transactions and blocks of the existing blockchain.

In some embodiments, the hybrid node includes the functionalities of the simple node as well as the miner node of the table-driven mutable blockchain. The simple node, the miner node and the hybrid node necessarily include: a User_Interface Module 508, for communication with the user 102; a Network_Interface module 510, for communication with the network 110; and a Control module 512, for the control and data flow inside the node 104. The other functions contained in nodes 104 can be categorized into main functions and retrieval functions. The presence or absence of these eleven functions depends on the kind of node and the functionalities it supports.

There are seven main functions, which include Transaction_Creating Module 514, Transaction Updating Module 516, Transaction Verifying Module 518, Block_Verifying Module 520, New_Transacion_Verifying Module 522, Block_Creating Module 524, and Block_Mining Module 526. The Transaction_Creating Module 514 allows a user 102 to create a first transaction 400 in the first blockchain B⁽¹⁾ for transferring money or writing a contract or committing to data. The Transaction Updating Module 516 allows a user 102 to update an existing transaction 400 and create a second transaction 450 in the second blockchains B⁽ⁱ⁾ (for 0<i<=p). The Transaction_Verifying Module 518 allows a node 104 in the network to verify if an existing transaction is valid or not. The Block_Verifying Module 520 allows a node 104 in the network to verify if an existing block 300 can be accepted or not. The New_Transacion_Verifying Module 522 allows a node 104 in the network to verify if a freshly created new transaction 400 or modified transaction 450 is valid or not. For a new transaction 400, it checks that none of the input transactions 416 have already been spent. For a modified transaction 450, it checks that none of the output transactions 425 have already been spent by any of the beneficiaries. The Block_Creating Module 524 allows a node 104 in a network to create a new block to be added to the existing blockchain. The Block_Mining Module 526 allows a node 104 in a network to verify and accept the freshly created new transactions 400 and modified transactions 450.

The four retrieval functions include Transaction_Retrieving Module 528, Versions_Retrieving Module 530, Statement_Retrieving Module 532 and Balance_Retrieving Module 534. The Transaction_Retrieving Module 528 allows a node 104 to retrieve the latest version of a transaction. The Versions_Retrieving Module 530 allows a node 104 to retrieve all the versions of a transaction. The Statement_Retrieving Module 532 allows a node 104 to retrieve a list of all the transactions associated with a user 102. The Balance_Retrieving Module 534 allows a node 104 to retrieve the current balance of a user 102.

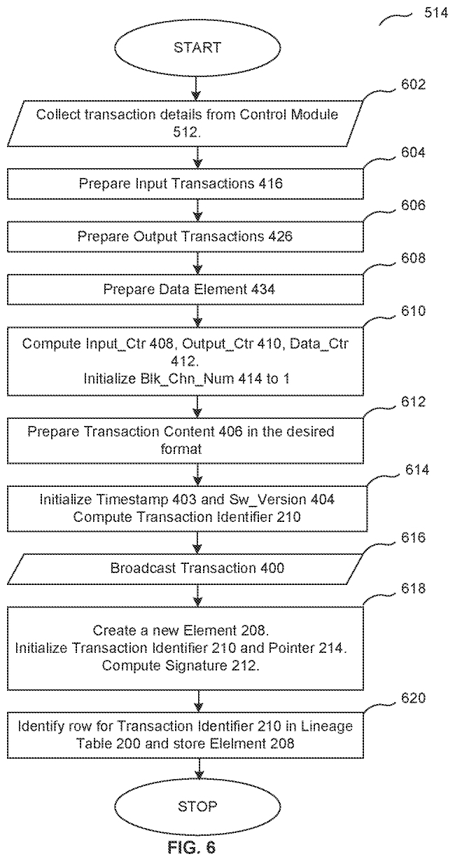

FIG. 6 is a flow diagram that illustrates a method of creating a first transaction in the first blockchain of the table-driven mutable blockchain system 100, according to some embodiments herein. The Transaction_Creating Module 514 is illustrated for creating the first transaction 400 in the first blockchain B⁽¹⁾ of the table-driven mutable blockchain. For the monetary transactions or contracts, the user defines Input Transactions 416 and Output Transactions 426. To commit to a data, the user defines the Data Element 434 only.

At step 602, the Transaction_Creating Module 514 collects the transaction details from the Control Module 512 and at step 604, prepares the details of each input transaction. The Transaction_Creating Module 514 computes the transaction identifier 210 for the input transaction, for example, Prev_Trnₘ 418M, in a blockchain B⁽¹⁾ and the index Idxₘ 420M in the latest version of Prev_Trnₘ 418M. The Transaction_Creating Module 514 reveals an unlocking condition Script_Sigₘ and its size Script_Sizeₘ 422M. In one of the embodiments, the unlocking condition may be the signature. In some embodiments, the Transaction_Creating Module 514 may supply any additional information related to the created transaction through a Seq_Noₘ 424M field. At step 606, the Transaction_Creating Module 514 prepares the details of each output transaction. In an exemplary representation, the Transaction_Creating Module 514 computes an index of output transaction Idxₙ 428N; assigns an amount of money Amountₙ 430N; and defines the unlocking condition Script_Pubₙ and its size Script_Sizeₙ 432N. At step 608, the Transaction_Creating Module 514 prepares the details of the data element. The Transaction_Creating Module 514 defines a public key Key_Value 442 and its size Key_Size 436; defines and writes data into Data_Value 444 and its size Data_Size 438; and computes the signature on the Data_Value 444 field as Sign_Value 446 and its size Sign_Size 440. At step 610, the Transaction_Creating Module 514 computes the number of input and output transactions as an Input_Ctr 408 field and an Output_Ctr 410 field, the size of the data element field as a Data_Ctr 412 field, and initializes the Blk_Chn_Num 414 field to 1. In some embodiments, at step 612, the Transaction_Creating Module 514 prepares the transaction contents 406 in the desired format. At step 614, the Transaction_Creating Module 514 inserts a creation time of the transaction in a Timestamp 402 field and blockchain software version information in a Sw_Version 404 field. Additionally, at step 614, the Transaction_Creating Module 514 computes and stores a hash of the transaction content 406 as the transaction identifier 210. Now, at step 616, the Transaction_Creating Module 514 broadcasts the freshly created Transaction 400.

At step 618, to update the Lineage Table 200, the Transaction_Creating Module 514 creates a new Element 208, initializes its transaction identifier 210 and pointer 214, and computes the signature 212. At step 620, the Transaction_Creating Module 514 identifies the row corresponding to the transaction identifier 210 in the Lineage Table 200 to store the Element 208, computed in step 618.

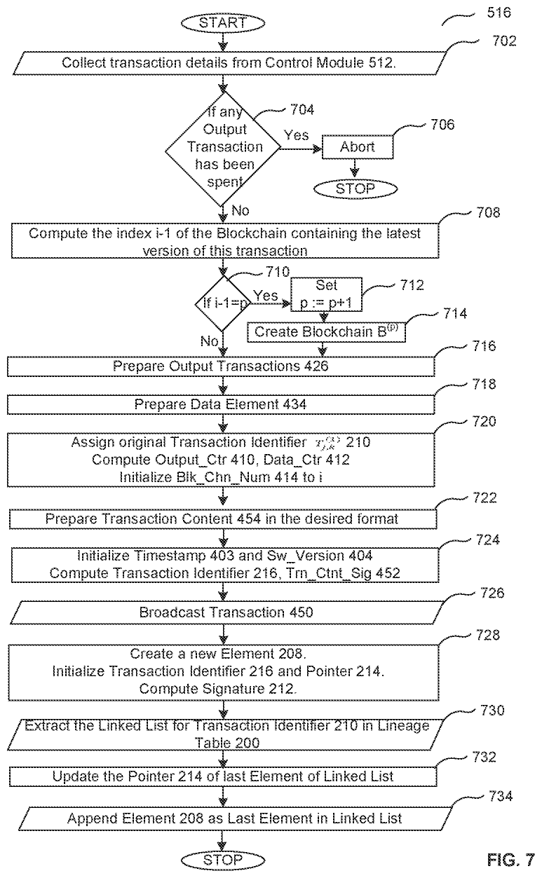

FIG. 7 is a flow diagram that illustrates a method of creating a second transaction in the second blockchain, of the table-driven mutable blockchain system 100, according to some embodiments herein. The method of creating a second transaction in the second blockchain includes Transaction_Updating Module 516 for creating a second transaction 450 in the second blockchain of the table-driven mutable blockchain system 100 of FIG. 1. For the monetary transactions or contracts, the user updates the Output Transactions 426. To commit to a data, the user updates the Data Element 434.

The Transaction_Updating Module 516 updates the transaction 400 based on the transaction details, collected from the Control Module 512 in step 702. In some embodiments, the output transactions 426 may be spent by the user 102A-102N and that leads the Transaction_Updating Module 516 to abort, as shown in steps 704 and 706. To create an second transaction in the second blockchain and adding a new element as first entry in the entry for the Lineage Table 200, the output transactions 426 need to be unspent. In step 708, the Transaction_Updating Module 516 determines the index (i−1) of the blockchain that contains the latest version of this transaction. At step 710, the Transaction_Updating Module 516 checks if the value of (i−1) is equal to the value of the global variable p. If true, then in step 712, the value of global variable P is updated to (p+1), and at step 714, the Transaction_Updating Module 516 creates a second blockchain B).

At step 716, the Transaction Updating Module 516 prepares the details of each output transaction. In an exemplary representation, the Transaction_Updating Module 516 computes an index of output transaction Idxₙ 428N; assigns an amount of money Amountₙ 430N; and defines the unlocking condition Script_Pubₙ and its size Script_Sizeₙ 432N.

At step 718, the Transaction_Updating Module 516 prepares the details of the data element. The Transaction_Updating Module 516 defines a public key Key_Value 442 and its size Key_Size 436; defines and writes data into Data_Value 444 and its size Data_Size 438; and computes the signature on the Data_Value 444 field as Sign_Value 446 and its size Sign_Size 440.

At step 720, the Transaction_Updating Module 516 assigns value to the transaction identifier 210 field, computes the number of output transactions as an Output_Ctr 410 field, the size of the data element field as a Data_Ctr 412 field, and initializes the Blk_Chn_Num 414 field to i. In some embodiments, i is a natural number representing the index of blockchain, for example, B⁽²⁾, B⁽³⁾, . . . , B^{(p)}.

In some embodiments, at step 722, the Transaction_Updating Module 516 prepares the transaction contents 454 in the desired format. At step 724, the Transaction_Updating Module 516 inserts a creation time of the transaction in a Timestamp 402 field and blockchain software version information in a Sw_Version 404 field.

Additionally, at step 724, the Transaction_Updating Module 516 computes and stores a hash of the transaction content 454 as the transaction identifier 216, and computes and stores the signature on the transaction content 454 in the Trn_Ctnt_Sig 452 field. Now, at step 726, the Transaction_Updating Module 516 broadcasts the freshly created Transaction 450.

At step 728, to update the Lineage Table 200, the Transaction_Updating Module 516 creates a new Element 208, initializes its transaction identifier 216 and pointer 214, and computes the signature 212. At step 730, the Transaction_Updating Module 516 identifies the row corresponding to the transaction identifier 210 in the Lineage Table 200 and extracts the Linked List.

At step 732, the Transaction Updating Module 516 updates the pointer 214 of last element of Linked List to the Element 208. At step 734, the Transaction_Updating Module 516 appends the Element 208, computed in step 628, as the last Element in the Linked List and updates the Lineage Table 200.

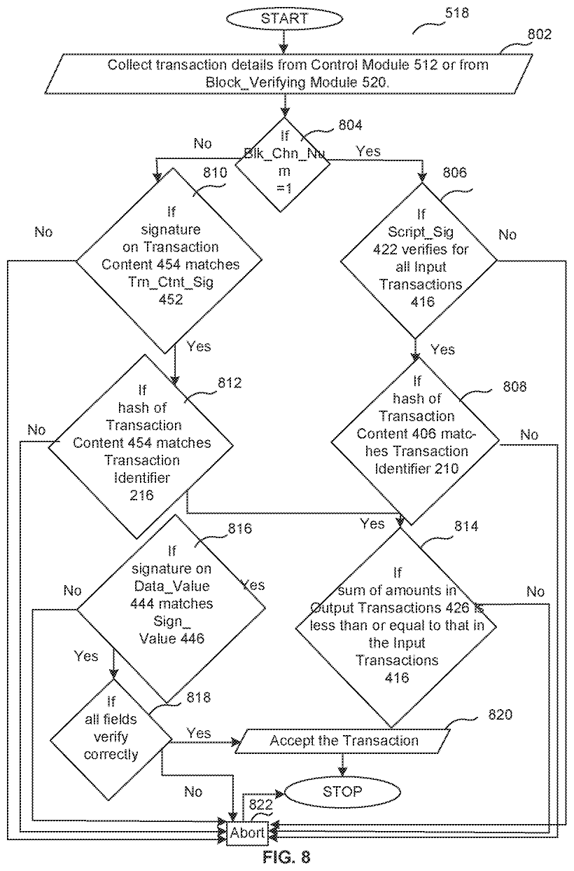

FIG. 8 is a flow diagram that illustrates a method of verifying existing first and second transactions of the table-driven mutable blockchain system 100 according to some embodiments herein. The method of verifying an existing transaction involves a Transaction_Verifying Module 518 for verifying an existing transaction 400 or 450 of the table-driven mutable blockchain. At step 802, the Transaction_Verifying Module 518 collects the transaction details from Control Module 512 or from Block_Verifying Module 520. During the process, wherever the Transaction_Verifying Module 518 check results into false, it aborts, as shown in step 822. At step 804, the Transaction_Verifying Module 518 checks the value of the Blk_Chn_Num 414 field. If the value of Blk_Chn_Num 414 is 1, at step 806, the Transaction_Verifying Module 518 checks if the Script_Sig 422 verifies for all Input Transactions 416, and then, at step 808, the Transaction_Verifying Module 518 checks if the hash of the transaction content 406 matches the transaction identifier 210. If the value of Blk_Chn_Num 414 is not 1 in step 804, then, at step 810, the Transaction_Verifying Module 518 checks if the signature on transaction content 454 matches the value of Trn_Ctnt_Sig 452 field, and then, at step 812, the Transaction_Verifying Module 518 checks if the hash of the transaction content 454 matches the transaction identifier 216. After successful verification in steps 808 and 812, the Transaction_Verifying Module 518 checks if the sum of all the amounts in the Output Transactions 426 is less than or equal to that in the Input Transactions 416, at step 814. Next, at step 816, the Transaction_Verifying Module 518 verifies the signature Sign_Value 446 on Data_Value 444. At step 818, the Transaction_Verifying Module 518 verifies the values in other fields for their correctness. Then, at step 820, the transaction is accepted.

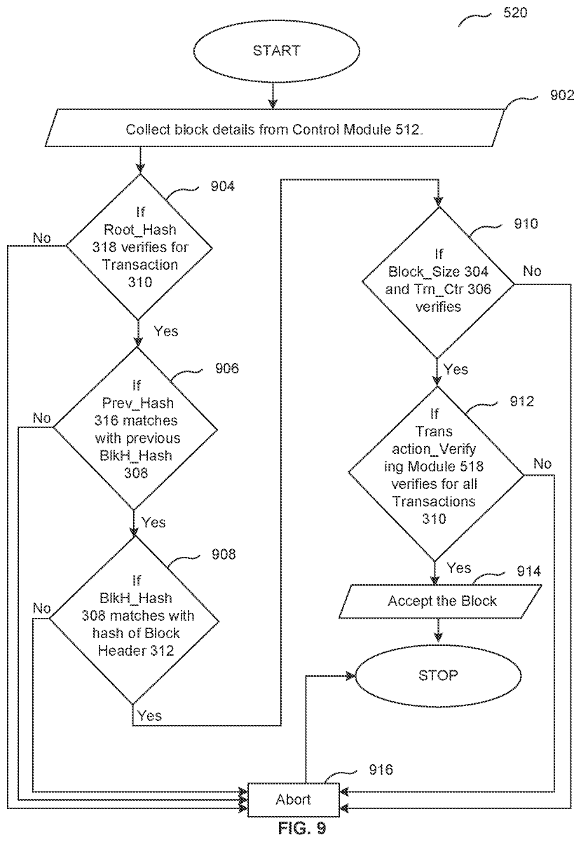

FIG. 9 is a flow diagram that illustrates a method of verifying existing first and second blocks of the table-driven mutable blockchain system 100, according to some embodiments herein. At step 902, the Block_Verifying Module 520 collects the block details from Control Module 512. During the process, wherever the Block_Verifying Module 520 check results into false, it aborts, as shown in step 916. At step 904, the Block_Verifying Module 520 verifies the value of the Root_Hash 318 against the Merkle root computed on Transactions 310. At step 906, the Block_Verifying Module 520 checks if the value of Prev_Hash 316 field matches with the BlkH_Hash 308 field of the previous Block in the blockchain. At step 908, the Block_Verifying Module 520 checks if the hash of the Block Header 312 matches the BlkH_Hash 308 field. At step 910, the Block_Verifying Module 520 verifies the correctness of the Block_Size 304 and Trn_Ctr 306 fields. At step 912, the Block_Verifying Module 520 invokes the Transaction_Verifying Module 518 for all Transactions 310 to check the correctness of each transaction. After successful verification in step 912, the Block_Verifying Module 520 accepts the Block, in step 914.

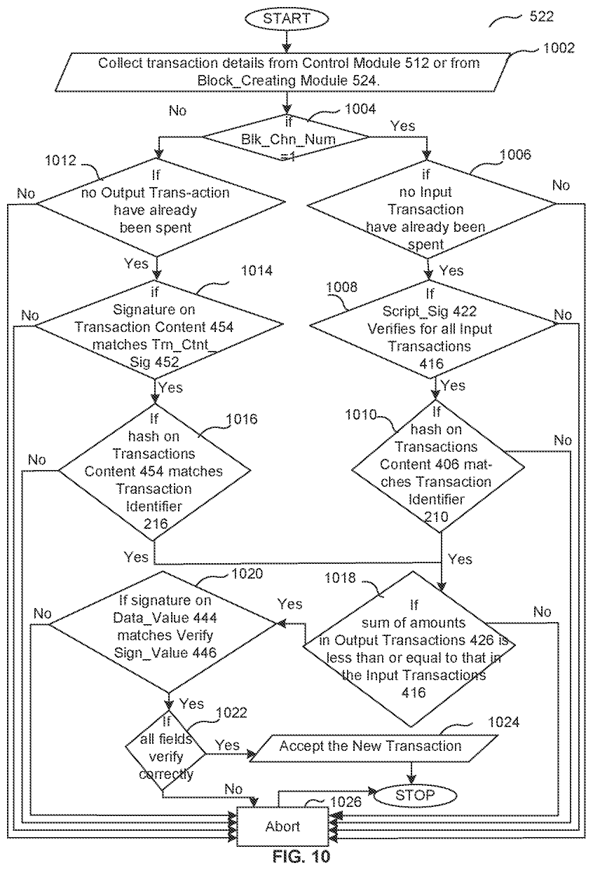

FIG. 10 is a flow diagram that illustrates a method of verifying new first and second transactions of the table-driven mutable blockchain system 100 of FIG. 1, according to some embodiments herein. At step 1002, the New_Transaction_Verifying Module 522 collects the transaction details from Control Module 512 or from Block_Creating Module 524. During the process, wherever the New_Transaction_Verifying Module 522 check results into false, except of step 1004, it aborts, as shown in step 1026. At step 1004, the New_Transaction_Verifying Module 522 checks the value of the Blk_Chn_Num 414 field. If the value of Blk_Chn_Num 414 is 1, at step 1006, the New_Transaction_Verifying Module 522 checks if any of the Input Transactions 416 have already been spent by the user 102, then, at step 1008, the New_Transaction_Verifying Module 522 checks if the Script_Sig 422 verifies for all Input Transactions 416, and then, at step 1010, the New_Transaction_Verifying Module 522 checks if the hash of the transaction content 406 matches the transaction identifier 210. If the value of Bik_Chn_Num 414 is not 1 in step 1004, then, at step 1012, the New_Transaction_Verifying Module 522 checks if any of the Output Transactions 426 have already been spent by the user 102, then, at step 1014, the New_Transaction_Verifying Module 522 checks if the signature on transaction content 454 matches the value of Trn_Ctnt_Sig 452 field, and then, at step 1016, the New_Transaction_Verifying Module 522 checks if the hash of the transaction content 454 matches the transaction identifier 216. After successful verification in steps 1010 and 1016, the New_Transaction_Verifying Module 522 checks if the sum of all the amounts in the Output Transactions 426 is less than or equal to that in the Input Transactions 416, at step 1018. Next, at step 1020, the New_Transaction_Verifying Module 522 verifies the signature Sign_Value 446 on Data_Value 444. At step 1022, the New_Transaction_Verifying Module 522 verifies the values in other fields for their correctness. Then, at step 1024, the freshly created transaction is accepted.

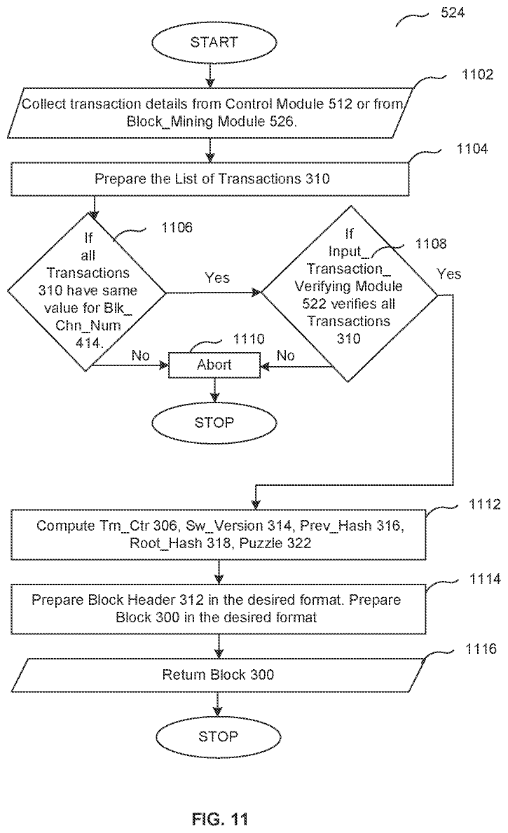

FIG. 11 is a flow diagram that illustrates a method of creating first and second blocks of the table-driven mutable blockchain system 100, according to some embodiments herein. At step 1102, the Block_Creating Module 524 collects the transaction details from the Control Module 512 or from Block_Mining Module 526, and at step 1104, prepares the list of transactions 310. At step 1106, the Block_Creating Module 524 checks if each transaction in the List of Transactions 310 have the same value for Blk_Chn_Num 414 field.

At step 1108, the Block_Creating Module 524 invokes the New_Transaction_Verifying Module 522 for each transaction in the List of Transactions 310 to check the correctness of all transactions. If either of the two checks at steps 1106 or 1108 fail, the Block_Creating Module 524 aborts, as shown in step 1110. If the two checks pass successfully, at step 1112, the Block_Creating Module 524 computes the number of transactions in the list of transactions 310 as a Trn_Ctr 306, inserts the blockchain software version information in a Sw_Version 314 field, and assigns the value of BlkH_Hash 308 of the newest block in the existing blockchain as Prev_Hash 316. Additionally, in step 1112, the Block_Creating Module 524 computes the Merkle root of the Transactions 310 as Root_Hash 318 and the difficulty level for the Proof-of-Work as Puzzle 322. In some embodiments, at step 1114, the Block_Creating Module 524 prepares the Block Header 312 in the desired format, and then Block 300 in the desired format. Now, at step 1116, the Block_Creating Module 524 returns the freshly created Block 300 to the calling function.

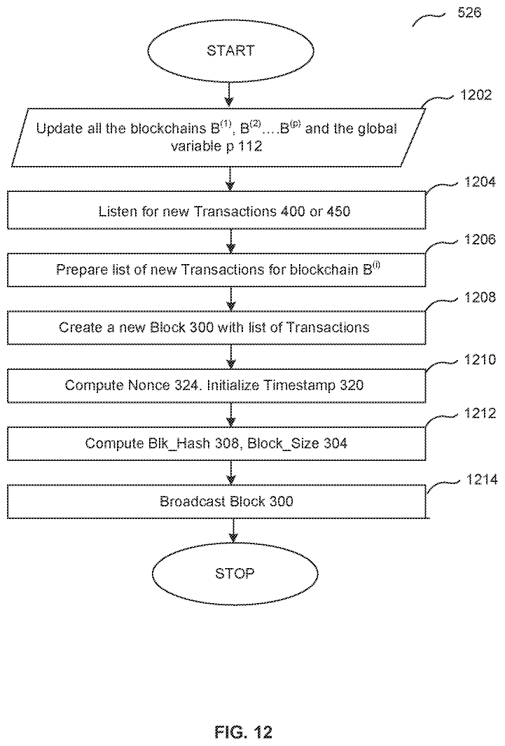

FIG. 12 is a flow diagram that illustrates a method of mining first and second blocks of the table-driven mutable blockchain system 100, according to some embodiments herein. The method for mining a first block includes a Block_Mining Module 526. The node 104 authenticates the freshly created first transactions and second transactions using a Block_Mining Module 526. In some embodiments, at step 1202, the Block_Mining Module 526, consistently checks for the new blocks that are being created and validate them using the Block_Verifying Module 520 before accepting and adding to the blockchains, thereby keeps updating the blockchains B⁽¹⁾, B⁽²⁾, . . . , B^{(p)} and the global variable P 112. In step 1204, the Block_Mining Module 526 collects all the freshly created transactions 400 or 450 being created and broadcasted by the users 102A-102N. In step 1206, the Block_Mining Module 526 prepares a list of all the new valid and unspent transactions in one blockchain. In step 1208, the Block_Mining Module 526 computes a candidate block 300—consisting of transactions in the list—using the Block_Creating Module 524, with the list of transactions computed in step 1206. In some embodiments, in step 1210, the Block_Mining Module 526 computes the solution of the Puzzle 322 as the Nonce 324 field, which is a computationally intensive step. Additionally, in step 1210, the Block_Mining Module 526 adds the creation time Timestamp 320. In step 1212, the Block_Mining Module 526 computes and stores the cryptographic hash of the block header 312 in the BlkH_Hash 308 field and also computes the size of the block as Block_Size 304 field. Now, at step 1214, the Block_Mining Module 526 broadcasts the freshly mined Block 300.

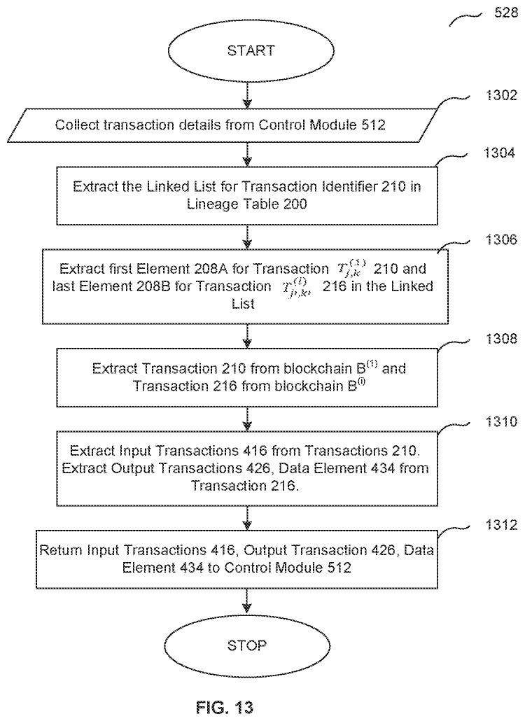

FIG. 13 is a flow diagram that illustrates a method of retrieving the latest version of a transaction 210 of the table-driven mutable blockchain system 100, according to some embodiments herein. The method includes a Transaction_Retrieving Module 528. In step 1302, the Transaction_Retrieving Module 528 collects the transaction details from Control Module 512. In step 1304, the Transaction_Retrieving Module 528 extracts the Linked List for Transaction Identier 210 in Lineage Table 200, and verifies the signature 212 stored in each Element 208 of the Linked List. In step 1306, the Transaction_Retrieving Module 528 extracts the first Element 208A for Transaction 210 and the last Element 208B for Transaction 216 in the Linked List. In step 1308, the Transaction_Retrieving Module 528 extracts Transaction 210 from blockchain B⁽¹⁾ and Transaction 216 from blockchain B⁽ⁱ⁾, and verifies them. In step 1310, the Transaction_Retrieving Module 528 extracts Input Transactions 416 from Transaction 210 and extracts Output Transactions 426, and Data Element 434 from Transaction 216. In step 1312, the Transaction_Retrieving Module 528 returns Input Transactions 416, Output Transactions 426, Data Element 434 to Control Module 512.

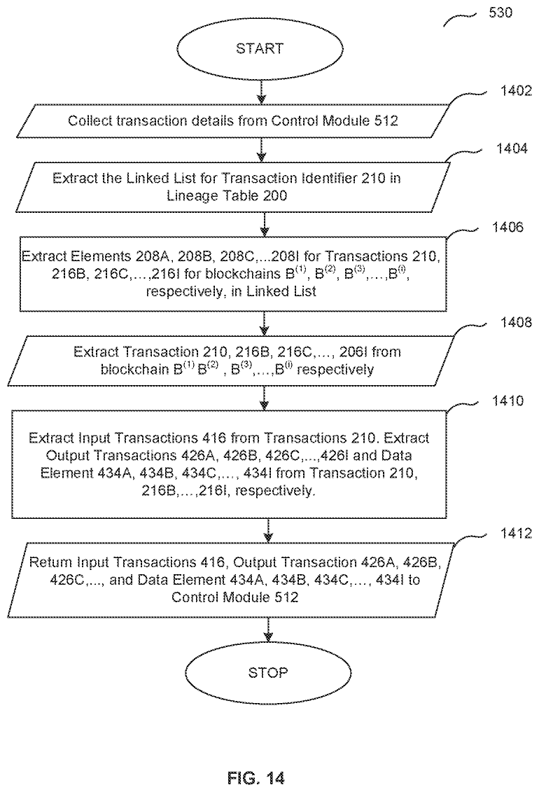

FIG. 14 is a flow diagram that illustrates a method of retrieving all the versions of a transaction 210 of the table-driven mutable blockchain system 100, according to some embodiments herein. The method for retrieving all the versions of a transaction includes the Versions_Retrieving Module 530. In step 1402, the Versions_Retrieving Module 530 collects the transaction details from Control Module 512. In step 1404, the Versions_Retrieving Module 530 extracts the Linked List for Transaction Identier 210 in Lineage Table 200, and verifies the signature 212 stored in each Element 208 of the Linked List. In step 1406, the Versions_Retrieving Module 530 extracts the Elements 208A, 208B, 208C, . . . , 2081 for Transactions 210, 216B, 216C, . . . , 2161 for blockchains B⁽¹⁾, B⁽²⁾, B⁽³⁾, . . . , B⁽ⁱ⁾, respectively, in the Linked List. In step 1408, the Versions_Retrieving Module 530 extracts Transactions 210, 216B, 216C, . . . , 2161 from blockchains B⁽¹⁾, B⁽²⁾, B⁽³⁾, . . . , B⁽ⁱ⁾, respectively, and verifies them. In step 1410, the Versions_Retrieving Module 530 extracts Input Transactions 416 from Transaction 210 and extracts Output Transactions 426A, 426B, 426C, . . . , 426I, and Data Element 434A, 434B, 434C, . . . , 434I from Transactions 210, 216B, 216C, . . . , 2161, respectively. In step 1412, the Versions_Retrieving Module 530 returns Input Transactions 416, Output Transactions 426A, 426B, 426C, . . . , 426I, and Data Elements 434A, 434B, 434C, . . . , 434I to Control Module 512.

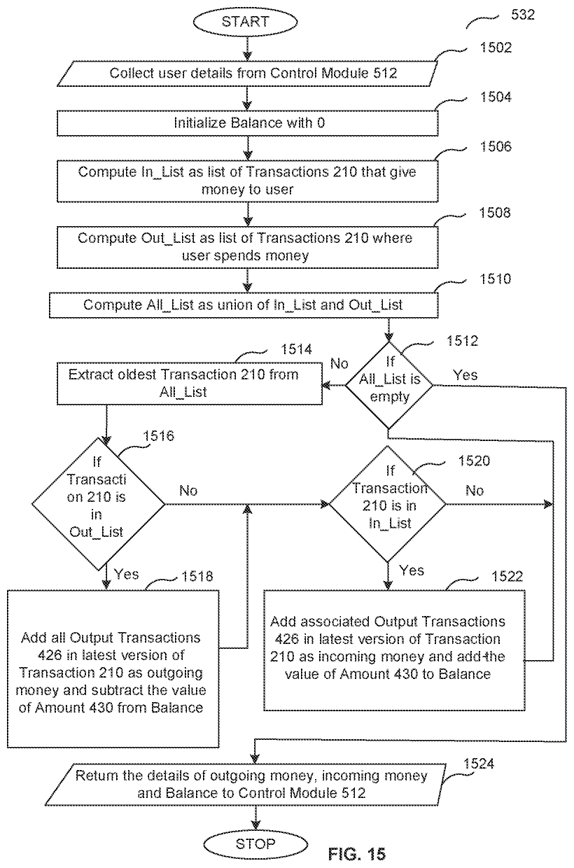

FIG. 15 is a flow diagram that illustrates a method of retrieving the list of all transactions corresponding to a user 102 of the table-driven mutable blockchain system 100 of FIG. 1, according to some embodiments herein. In step 1502, the Statement_Retrieving Module 532 collects user details from the Control Module 512. In step 1504, the Statement_Retrieving Module 532 initializes a variable Balance with 0. In step 1506, the Statement_Retrieving Module 532 computes In_List as the list of Transactions 210 that give money to the user. In step 1508, the Statement_Retrieving Module 532 computes Out_List as the list of Transactions 210 where the user spends money. In step 1510, the Statement_Retrieving Module 532 computes All_List as the union of In_List and Out_List. In step 1512, the Statement_Retrieving Module 532 checks if the All_List is empty. If true, the Statement_Retrieving Module 532 jumps to step 1524, otherwise it executes step 1514. In step 1514, the Statement_Retrieving Module 532 extracts oldest Transaction 210 from All_List. In step 1516, the Statement_Retrieving Module 532 checks if the extracted transaction 210 is in Out_List. If true, the Statement_Retrieving Module 532 executes step 1518, otherwise jumps to step 1520. In step 1518, the Statement_Retrieving Module 532 adds all Output Transactions 426 in the latest version of Transaction 210 as outgoing money and subtract the value of Amount 430 from Balance. In step 1520, the Statement_Retrieving Module 532 checks if the extracted transaction 210 is in In_List. If true, the Statement_Retrieving Module 532 executes step 1522, otherwise jumps to step 1512. In step 1522, the Statement_Retrieving Module 532 adds the associated Output Transaction 426 in the latest version of Transaction 210 as incoming money and adds the value of Amount 430 to Balance. In step 1524, the Statement_Retrieving Module 532 returns the details of outgoing money, incoming money and Balance to Control Module 512.

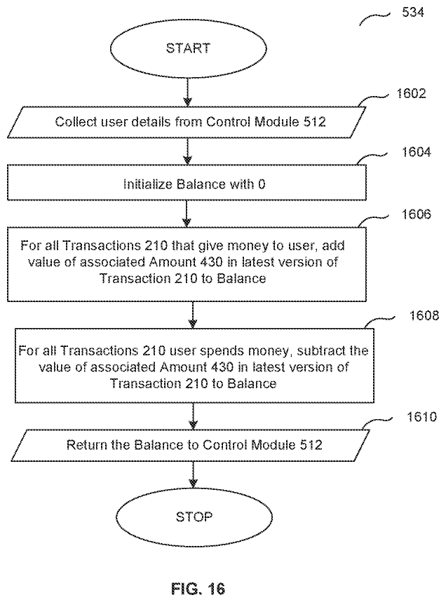

FIG. 16 is a flow diagram that illustrates a method of retrieving the current balance of a user 102 of the table-driven mutable blockchain system 100 of FIG. 1, according to some embodiments herein. In step 1602, the Balance_Retrieving Module 534 collects user details from the Control Module 512. In step 1604, the Balance_Retrieving Module 534 initializes a variable Balance with 0. In step 1606, for all Transactions 210 that give money to user, the Balance_Retrieving Module 534 adds the value of associated Amount 430 in latest version of Transaction 210 to Balance. In step 1608, for all Transactions 210 where user spends money, the Balance_Retrieving Module 534 subtract the value of associated Amount 430 in latest version of Transaction 210 from Balance. In step 1610, the Balance_Retrieving Module 534 returns Balance to Control Module 512.

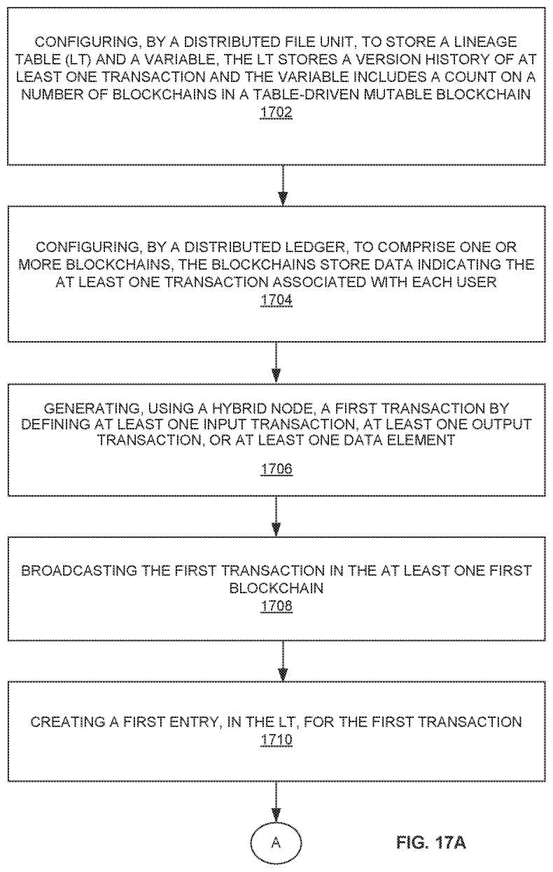

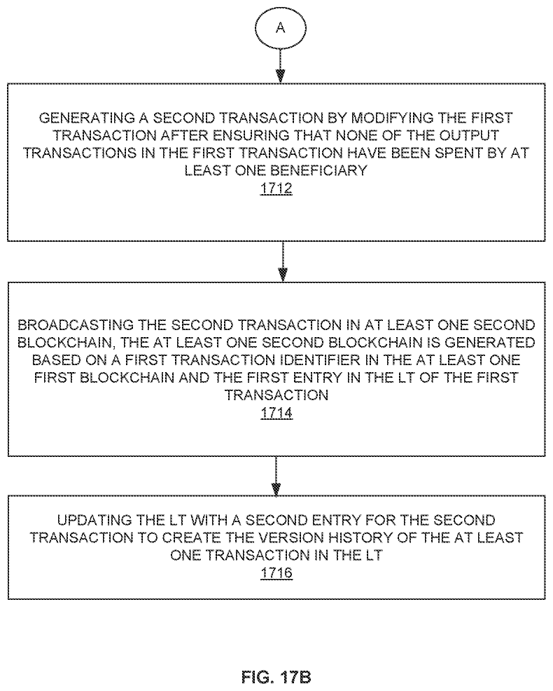

FIGS. 17A and 17B are flow diagrams that illustrate a method for enabling to modify a transaction in a block of first blockchain and generating a second blockchain with modified transaction, of the table-driven mutable blockchain system, according to some embodiments herein. At step 1702, the method includes configuring, by a distributed file unit, to store a lineage table (LT), and a global variable, the LT stores a version history of at least one transaction and the global variable comprises a count on a number of blockchains in the table-driven mutable blockchain. At step 1704, the method includes configuring, by a distributed ledger, to comprise a plurality of blockchains, the plurality of blockchains store data indicating the at least one transaction associated with each user. At step 1706, the method includes generating a first transaction, using a plurality of nodes associated with a plurality of users, by defining at least one input transaction, at least one output transaction or at least one data element, the plurality of nodes comprise at least one hybrid node. At step 1708, the method includes broadcasting the first transaction in the at least one first blockchain. At step 1710, the method includes creating a first entry, in the LT, for the first transaction. At step 1712, the method includes generating a second transaction by modifying the first transaction after ensuring that none of the output transactions in the first transaction have been spent by at least one beneficiary. At step 1714, the method includes broadcasting the second transaction in at least one second blockchain, the at least one second blockchain is generated based on a first transaction identifier in the at least one first blockchain and the first entry in the LT for the first transaction. At step 1716, the method includes updating the LT with a second entry for the second transaction to create the version history of the at least one transaction in the LT.

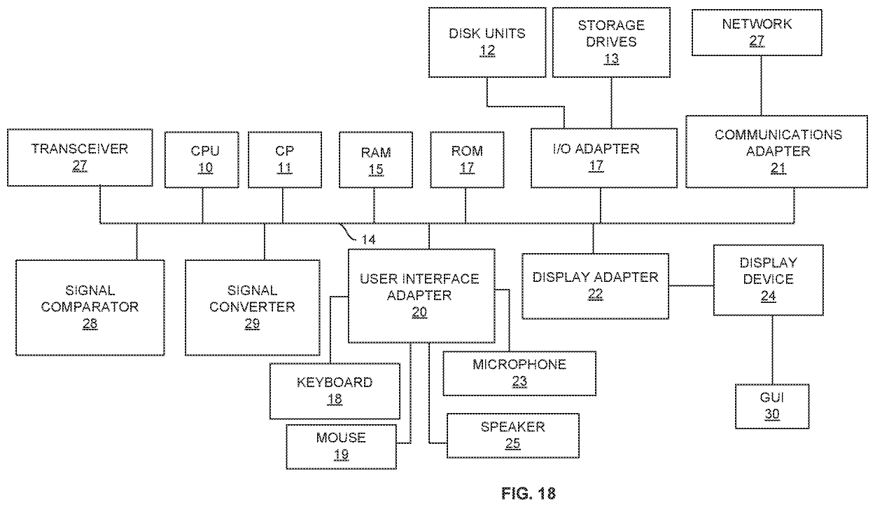

A representative hardware environment for practicing the embodiments herein is depicted in FIG. 18, with reference to FIGS. 1 through 17A and 17B. This schematic drawing illustrates a hardware configuration of a plurality of nodes 104A-N/computer system/computing device in accordance with the embodiments herein. The system includes at least one processing device CPU 10 that may be interconnected via system bus 14 to various devices such as a random access memory (RAM) 12, read-only memory (ROM) 16, and an input/output (I/O) adapter 18. The I/O adapter 18 can connect to peripheral devices, such as disk units 38 and program storage devices 40 that are readable by the system. The system can read the inventive instructions on the program storage devices 40 and follow these instructions to execute the methodology of the embodiments herein. The system further includes a user interface adapter 22 that connects a keyboard 28, mouse 30, speaker 32, microphone 34, and/or other user interface devices such as a touch screen device (not shown) to the bus 14 to gather user input. Additionally, a communication adapter 20 connects the bus 14 to a data processing network 42, and a display adapter 24 connects the bus 14 to a display device 26, which provides a graphical user interface (GUI) 36 of the output data in accordance with the embodiments herein, or which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

What is claimed is:

1. A table-driven mutable blockchain system for enabling to modify at least one transaction in at least one block of at least one first blockchain and generating at least one second blockchain with modified transaction, the blockchain system comprising:
a distributed file unit that is configured to store a lineage table (LT), and a global variable, wherein the LT stores a version history of at least one transaction and the global variable comprises a count on a number of blockchains in the table-driven mutable blockchain;
a distributed ledger that comprises a plurality of blockchains, wherein the plurality of blockchains store data indicating the at least one transaction associated with each user;
a plurality of nodes associated with a plurality of users, wherein the plurality of nodes comprises at least one hybrid node, wherein the at least one hybrid node comprises,
a device processor; and
a non-transitory computer-readable storage medium storing one or more sequences of instructions, which when executed by the device processor, causes:
generating a first transaction by defining at least one input transaction, at least one output transaction or at least one data element:
broadcasting the first transaction in the at least one first blockchain;
creating a first entry, in the LT, for the first transaction;
generating a second transaction by modifying the first transaction after ensuring that none of the output transactions in the first transaction have been spent by at least one beneficiary;
broadcasting the second transaction in at least one second blockchain, wherein the at least one second blockchain is generated based on a first transaction identifier in the at least one first blockchain and the first entry in the LT for the first transaction; and
updating the LT with a second entry for the second transaction to create the version history of the at least one transaction in the LT.

2. The system of claim 1, wherein the processor is configured to generate the first transaction by,
collecting transaction details to prepare details of the at least one input transaction, and the at least one output transaction;
determining details of the at least one input transaction by computing a transaction identifier a first index for the at least one input transaction and revealing the unlocking condition of the at least one input transaction, wherein an unlocking condition is a cryptographic signature;
determining details of the at least one output transaction by computing a second index for the at least one output transaction and defining the unlocking condition of the at least one input transaction and a size of the unlocking condition;
generating the first transaction using details of the at least one data element by (i) defining a public key and a size of the public key, (ii) defining and writing data into data value field of the first transaction and a size of the data into size value field of the first blockchain, and (iii) computing a signature and a size of the signature on the data value field of the first transaction;
computing a number of input transactions and a number of output transactions to corresponding an input count field and an output count field;
inserting a creation time stamp of the first transaction to a timestamp field and blockchain software version information in a version field;
storing a hash of the at least one input transaction, the at least one output transaction and the at least one data element, as the transaction identifier;
updating the LT table by creating the first entry by initializing the transaction identifier and computing the signature; and
identifying a row corresponding to the transaction identifier in the LT table to store the first entry.

3. The system of claim 1, wherein the processor is configured to generating the second transaction by modifying the first transaction by,
updating the first transaction based on the transaction details;
adding the second entry in the LT table;
determining the index of the blockchain that comprises a latest version of the second transaction;
checking if the index is equal to the global variable;
updating the global variable by adding one if the index is equal to the global variable;
creating the at least one second blockchain;
preparing details of the at least one output transaction;
preparing details of the at least one data element to write the data into a field of data value and a size of the data into a field of data size, wherein a public key and a size of the public key are defined to the at least one data element;
assigning a value to the transaction identifier of the second transaction to compute a number of output transactions;
initializing a number to a field of number of the blockchain;
inserting a creation time stamp of the second transaction to the timestamp field and blockchain software version information in the version field;
computing and storing the hash of the at least one input transaction and the at least one output transaction, as the transaction identifier;
computing and storing the signature of the at least one input transaction and the at least one output transaction, in a field of transaction signature;
broadcasting the second transaction that is created newly;
updating the LT table by initializing the transaction identifier of the second transaction and a pointer and computing the signature;
identifying a row corresponding to the transaction identifier of the second transaction in the LT table to extract the linked list;
updating the pointer of last element of the linked list to the element of the first transaction; and
appending the first transaction as the last element in the linked list and updating the LT table.

4. The system of claim 1, wherein the processor is configured to verify the first transaction and the second transaction that is modified of the table-driven mutable blockchain by,
collecting the transaction details of transaction and aborting verification process if the transaction details are not found;
checking if any of the at least one input transaction for the verification if a value of block chain number field is one and checking if the script signature is present for all the input transactions;
checking if any of the at least one output transaction is executed by the user when the hash of the first transaction is matched with the transaction identifier;
checking if the signature on transaction content matches with a value of transaction content signature field;
checking if the hash of the first transaction content matches with the transaction identifier;
checks if sum of all the amounts in the at least one output transaction is less than or equal to that in the amounts in the at least one input transaction; and
verifying the signature on data value and values in other fields for correctness, thereby accepting the transaction.

5. The system of claim 1, wherein the processor is configured to create the at least one second block for the at least one second blockchain of the table-driven mutable blockchain by,
collecting the transaction details and preparing a list of transactions;
checking if each transaction in the list of transactions matches with same value for the value of blockchain number field;
checking correctness of each transaction in the list of transactions;
computing the number of transactions in the list of transactions if the correctness of each transaction and the matching in previous steps are successful and inserting the blockchain software version information in a field of software version and assigning the value of hash of the latest block in existing blockchain;
computing a merkle root of the transactions and a puzzle; and
preparing a header of the block in a format, and the block in the format.

6. The system of claim 1, wherein the processor is configured to mine the first block of the table-driven mutable blockchain by,
collecting all new transactions and preparing a list of all new transactions that are valid in one blockchain;
computing a candidate block that comprises the list of transactions with the list of all new transactions that are valid;
computing a solution of the puzzle as a nonce field; and
computing and storing the hash of the header of the block and the size of the block.

7. The system of claim 1, wherein the processor is configured to retrieve a latest version of the transaction of the table-driven mutable blockchain by,
collecting transaction details of the transaction;
extracting a linked list for the transaction identifier in the LT, and verifying the signature stored in each element of the linked list;
extracting a first element for the transaction and a last element of the transaction;
extracting and verifying the transaction from the first blockchain, and the transaction from the i^{th} blockchain; and
extracting and returning the input transactions, the output transactions, and data elements from the input transactions, and the output transactions.

8. The system of claim 1, wherein the processor is configured to retrieve all versions of the at least one transaction of the table-driven mutable blockchain by,
extracting the linked list for the transaction identifier in the LT, and verifying the signature stored in each element of the linked list;
extracting and verifying elements for the transactions for blockchains in the linked list;
extracting and verifying all the transactions from the blockchains in the linked list;
extracting and returning the input transactions, the output transactions, the data elements, from the transactions.

9. A processor-implemented method for enabling to modify at least one transaction in at least one block of at least one first blockchain and generating at least one second blockchain with modified transaction, the processor-implemented method comprising:
configuring, by a distributed file unit, to store a lineage table (LT), and a global variable, wherein the LT stores a version history of at least one transaction and the global variable comprises a count on a number of blockchains in the table-driven mutable blockchain;
configuring, by a distributed ledger, to comprise a plurality of blockchains, wherein the plurality of blockchains store data indicating the at least one transaction associated with each user;
generating a first transaction, using a plurality of nodes associated with a plurality of users, by defining at least one input transaction, at least one output transaction, or at least one data element, wherein the plurality of nodes comprise at least one hybrid node;
broadcasting the first transaction in the at least one first blockchain;
creating a first entry, in the LT, for the first transaction;
generating a second transaction by modifying the first transaction after ensuring that none of the output transactions in the first transaction have been spent by at least one beneficiary;
broadcasting the second transaction in at least one second blockchain, wherein the at least one second blockchain is generated based on a first transaction identifier in the at least one first blockchain and the first entry in the LT for the first transaction; and
updating the LT with a second entry for the second transaction to create the version history of the at least one transaction in the LT.

10. The processor-implemented method of claim 9, further comprising to generate the first transaction by,
collecting transaction details to prepare details of the at least one input transaction, and the at least one output transaction;
determining details of the at least one input transaction by computing a transaction identifier a first index for the at least one input transaction and revealing an unlocking condition of the at least one input transaction, wherein the unlocking condition is a cryptographic signature;
determining details of the at least one output transaction by computing a second index for the at least one output transaction and defining the unlocking condition of first transaction and a size of the first transaction;
generating the first transaction using details of the at least one data element by (i) defining a public key and a size of the public key, (ii) defining and writing data into data value field of the first transaction and a size of the data into size value field of the first transaction, and (iii) computing a signature and a size of the signature on the data value field of the first transaction;
computing a number of input transactions and a number of output transactions to corresponding an input count field and an output count field;
inserting a creation time stamp of the first transaction to a timestamp field and blockchain software version information in a version field;
storing a hash of the at least one input transaction the at least one output transaction, and the at least one data element as the transaction identifier;
updating the LT table by creating the first entry by initializing the transaction identifier and computing the signature; and
identifying a row corresponding to the transaction identifier in the LT table to store the first entry.

11. The method of claim 9, further comprising to generate the second transaction by modifying the first transaction by,
updating the first transaction based on the transaction details;
adding the second entry in the LT table;
determining the index of the blockchain that comprises a latest version of the second transaction;
checking if the index is equal to the global variable;
updating the global variable by adding one if the index is equal to the global variable;
creating the at least one second blockchain;
preparing details of the at least one output transaction;
preparing details of the at least one data element to write the data into a field of data value and a size of the data into a field of data size, wherein a public key and a size of the public key are defined to the at least one data element;
assigning a value to the transaction identifier of the second transaction to compute a number of output transactions;
initializing a number to a field of number of the blockchain;
inserting a creation time stamp of the second transaction to the timestamp field and blockchain software version information in the version field;
computing and storing the hash of the at least one input transaction and the at least one output transaction, as the transaction identifier;
computing and storing the signature of the at least one input transaction and the at least one output transaction, in a field of transaction signature;
broadcasting the second transaction that is created newly;
updating the LT table by initializing the transaction identifier of the second transaction and a pointer and computing the signature;
identifying a row corresponding to the transaction identifier of the second transaction in the LT table to extract the linked list;
updating the pointer of a last element of the linked list to the element of the first transaction; and
appending the first transaction as the last element in the linked list and updating the LT table.

12. The method of claim 9, further comprising to verify the first transaction and the second transaction that is modified of the table-driven mutable blockchain by,
collecting the transaction details of transaction and aborting verification process if the transaction details are not found;
checking if any of the at least one input transaction for the verification if a value of blockchain number field is one and checking if the script signature is present for all the input transactions;
checking if any of the at least one output transaction is executed by the user when the hash of the first transaction is matched with the transaction identifier;
checking if the signature on transaction content matches with a value of transaction content signature field;
checking if the hash of the first transaction content matches with the transaction identifier;
checks if sum of all the amounts in the at least one output transaction is less than or equal to that in the amounts in the at least one input transaction; and
verifying the signature on data value and values in other fields for correctness, thereby accepting the transaction.

13. The method of claim 9, further comprising to create the at least one second block for the at least one second blockchain of the table-driven mutable blockchain by,
collecting the transaction details and preparing a list of transactions;
checking if each transaction in the list of transactions matches with same value for the value of blockchain number field;
checking correctness of each transaction in the list of transactions;
computing the number of transactions in the list of transactions if the correctness and the matching in previous steps are successful and inserting the blockchain software version information in a field of software version and assigning the value of hash of the latest blockchain in existing blockchain;
computing a merkle root of the transactions and a puzzle; and
preparing a header of the block in a format, and then the block in the format.

14. The method of claim 9, further comprising to mine the first block of the table-driven mutable blockchain by,
collecting all new transactions and preparing a list of all new transactions that are valid in one blockchain;
computing a candidate block that comprises the list of transactions with the list of all new transactions that are valid;
computing a solution of the puzzle as a nonce field; and
computing and storing the hash of the header of the block and the size of the block.

15. The method of claim 9, further comprising to retrieve a latest version of the transaction of the table-driven mutable blockchain by,
collecting transaction details of the transaction;
extracting a linked list for the transaction identifier in the LT, and verifying the signature stored in each element of the linked list;
extracting a first element for the transaction and a last element of the transaction;
extracting and verifying the transaction from the first blockchain, and the transaction from the i^{th} blockchain;
extracting and returning the input transactions, the output transactions, and data elements from the input transactions, the output transactions, and the data elements.

16. The method of claim 9, further comprising to retrieve all versions of the at least one transaction of the table-driven mutable blockchain by,
extracting the linked list for the transaction identifier in the LT, and verifying the signature stored in each element of the linked list;
extracting and verifying elements for the transactions for blockchains in the linked list;
extracting and verifying the transactions from the blockchains in the linked list;
extracting and returning the input transactions, the output transactions, the data elements, from the transactions.

17. One or more non-transitory computer-readable storage mediums storing one or more sequences of instructions, which when executed by one or more processors, causes a method for enabling to modify at least one transaction in at least one block of at least one first blockchain and generating at least one second blockchain with modified transaction, the method comprising:
configuring, by a distributed file unit, to store a lineage table (LT), and a global variable, wherein the LT stores a version history of at least one transaction and the global variable comprises a count on a number of blockchains in the table-driven mutable blockchain;
configuring, by a distributed ledger, to comprise a plurality of blockchains, wherein the plurality of blockchains store data indicating the at least one transaction associated with each user;
generating a first transaction, using a plurality of nodes associated with a plurality of users, by defining at least one input transaction, at least one output transaction or at least one data element, wherein the plurality of nodes comprise at least one hybrid node;
broadcasting the first transaction in the at least one first blockchain;
creating a first entry, in the LT, for the first transaction;
generating a second transaction by modifying the first transaction after ensuring that none of the output transactions in the first transaction have been spent by at least one beneficiary;
broadcasting the second transaction in at least one second blockchain, wherein the at least one second blockchain is generated based on a first transaction identifier in the at least one first blockchain and the first entry in the LT for the first transaction; and
updating the LT with a second entry for the second transaction to create the version history of the at least one transaction in the LT
